(19) United States
(12) Patent Application Publication
(10) Pub. No.: US 2008/0284595 A1
(43) Pub. Date: Nov. 20, 2008

(54) Window or Door Handle

(75) Inventor: Thomas Buchhalter, Niederkassel (DE)

Correspondence Address: DARBY & DARBY P.C., P.O. BOX 770, Church Street Station, New York, NY, 10008-0770, US

(73) Assignee: WERU AG, Rudersberg (DE)

(21) Appl. No.: 11/817,185

(22) PCT Filed: Feb. 27, 2006
(86) PCT No.: PCT/EP2006/001794

§ 371 Date: May 27, 2008

(30) Foreign Application Priority Data
Feb. 25, 2005 (EP) 05101470.2

(51) Int. Cl. G08B 13/08

(52) U.S. Cl. 340/545.2

(57) ABSTRACT

An olive-shaped window or door fitting includes a handle housed in a handle fitting, an autonomous monitoring and alarm module arranged in a module housing with several sensors, and an evaluation unit, which receives alarm signals and detection signals. The monitoring and alarm module has at least one handling noise sensors integrated into the module housing, which is directed towards a pane of glass and selectively records acoustic frequencies which occur when glass is broken and which in the event of glass being broken transmits an alarm signal to the evaluation device.

This is a U.S. National Phase application under 35 U.S.C. §371 of International Application No. PCT/EP2006/001794, filed Feb. 27, 2006 and claims the benefit of European Patent Application No. 05101470.2, filed on Feb. 25, 2005. The International Application was published in German on Aug. 31, 2006 as WO 2006/089794 under PCT Article 21 (2).

The invention relates to an olive-shaped window or door fitting.

### BACKGROUND

With such an olive-shaped window or door fitting a monitoring device is provided in which a sensor device in a window or a door detects the actuation of the handle and the presence of alarm signals.

### SUMMARY OF THE INVENTION

An object of the invention is to provide an olive-shaped window or door fitting which autonomously both forms a stand-alone alarm system and also can be integrated into a central monitoring station.

The invention advantageously provides that the monitoring and alarm module has at least one handling noise sensor integrated into the module housing which is directed towards a pane of glass and selectively records acoustic frequencies which occur when glass is broken and which in the event of glass being broken transmits an alarm signal to the evaluation device.

The handling noise sensor can selectively detect the acoustic frequency of a breakage of glass, wherein a precise detection can take place through the immediate proximity of the handling noise sensor or microphone to the pane of glass.

Preferably it is provided that the handling noise sensor can be activated by a vibration sensor. When a vibration sensor is used the handling noise sensor need not be permanently activated, which would lead to a high power consumption. The vibration sensor, preferably a piezoelectric quartz sensor, detects vibrations which precede a breakage of glass and only then activates the handling noise sensor e.g. by switching on the power supply. The vibration sensor is preferably attached at or against the pane of glass.

According to a preferred embodiment example the monitoring and alarm module has an integrated transmitter for an acoustic and/or visual signal. The monitoring and alarm module thus forms a decentralized monitoring device for windows, doors or other similar construction elements, wherein the acoustic signal transmitter can consist of a siren, a buzzer, a loudspeaker, or a bell. Additionally or alternatively a visual signal transmitter can for example consist of a stroboscope or a LED light. With the help of the transmitter for an acoustic and/or visual signal, not only can a remote transmission of the alarm signal via the monitoring and alarm signal to a central monitoring station take place but a local alarm can also be triggered. This is advisable in particular if e.g. a despatch of a wirelessly transmitted alarm signal to a central monitoring station is impeded by superimposition with interfering frequencies. In this case an attempted break-in is at least immediately acoustically and/or visually displayed at the relevant window.

The monitoring and alarm module preferably has status displays. These status displays can display the idle state of the monitoring and alarm module, the battery or cell state and other states connected with the alarm and detection signals.

The evaluation device can transmit a report signal to a central monitoring station. A transmitter is preferably provided for this which transmits the alarm and/or detection signals and/or the report signal of the evaluation device to a central monitoring station.

The invention also relates to a window or a door with a frame for encasing a pane of glass and with an olive-shaped window or door fitting of the previously-named type.

It is provided that the module housing is arranged sunk into a recess of the frame and that the frame has a sound duct which leads in the frame from the adjoining handling noise sensor in the module housing to the outer edge of the pane of glass.

The arrangement of the handling noise sensor in the module housing which is arranged sunk into a recess of the frame has the effect that the handling noise sensor is screened from other interfering noises, wherein noises from the pane of glass and of the frame, in particular the breaking frequencies can be detected undisturbed via the sound duct. A handling noise sensor arranged in such manner as a glassbreak sensor has the advantage that no installation errors can occur when attaching a glassbreak sensor to a pane of glass. Furthermore a better cleaning of the window surface is possible because this does not have a glassbreak sensor attached.

A breakage of glass can be detected with great precision without false alarms because the handling noise sensor is screened from interfering noises. Finally, there is the advantage of simple installation, as the monitoring and alarm module does not have to be wired to an external sensor.

In a development of the invention it can be provided that there is attached to or on the pane of glass or to the frame a solar cell which supplies the monitoring and alarm module with power. The power supply via a solar cell has the advantage that a cell can be supplied with current with the result that a regular replacement of the batteries for the power supply can be dispensed with.

### BRIEF DESCRIPTION OF THE DRAWINGS

Embodiment examples of the invention are described in more detail below with reference to the drawings. There are shown in:

FIG. 1 a perspective representation of a first embodiment example of the invention,

FIG. 2 a partial cross-section through the monitoring and alarm module, with olive-shaped fitting attached, and

FIG. 3 a top view of the embodiment example from FIG. 2 along the line III-III.

### DETAILED DESCRIPTION

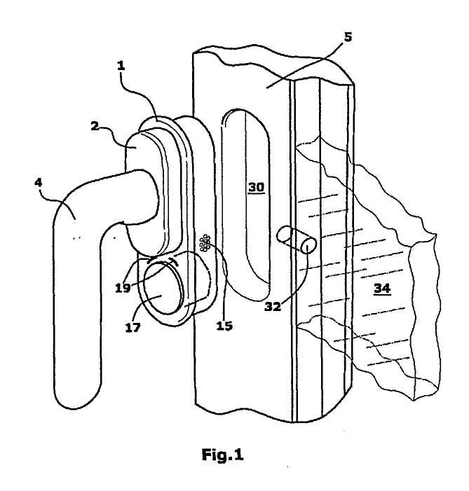

FIG. 1 shows an olive-shaped window or door fitting with a handle 4 housed in a handle fitting 2 and with an autonomous monitoring and alarm module 1 arranged in a module housing 26.

The monitoring and alarm module has its own power supply 18 and is therefore independent of the power feed. FIG. 1 shows an installation version for integrating the monitoring and alarm module 1 in the frame 5 of a window of a window or door wing. The monitoring and alarm module 1 can be arranged sunk into a recess 30, with the result that the olive-shaped window or door fitting sits on the wing frame 5 like a standard version with no alarm device.

An installation version is shown in which the olive-shaped window or door fitting is of conventional construction, wherein after exchanging a plug-in locking part 6 this is pushed through the monitoring and alarm module 1 and is fitted jointly with this.

The olive-shaped window or door fitting can however also form a structural unit with the monitoring and alarm module 1.

Furthermore there is also the possibility of attaching the olive-shaped window or door fitting to the frame with a separate monitoring and alarm module 1 jointly or as a structural unit without a recess 30 being required in the frame for this.

The monitoring and alarm module 1 is provided with a handling noise sensor 15 which is used as a glassbreak sensor and which is directed towards a pane of glass 34 and can selectively record acoustic frequencies which occur when glass is broken. In the event of glass being broken, an alarm signal is transmitted to an evaluation device 24. The handling noise sensor 15 operates particularly reliably if it is arranged sunk into the recess 30, as it is then largely shielded from interfering noises.

In order to even better transmit to the handling noise sensor the acoustic frequencies occurring when glass is broken, a sound duct 32 can be provided in the frame 5, running between the side glass edge of the pane of glass 34 and ending opposite the handling noise sensor 15 in the module housing 26.

The module housing 26 can furthermore have on its front an integrated acoustic signal transmitter 17 which for example consists of a siren. Alternatively or additionally visual signal transmitters, such as for example a stroboscope light or LED lights, can also be provided.

Finally, on the front of the module housing 26, several status displays 19 can be arranged which can display the status of the battery or of the cell 18 and the status of the monitoring and alarm module 1 or of the evaluation unit 24. For example it could also be displayed whether there is a radio link to a central monitoring station.

The monitoring and alarm module 1 forms a stand-alone alarm system which is independent of the power supply and functions fully automatically. No activation or deactivation of the monitoring and alarm module 1 is necessary. Malfunctions are almost completely ruled out. Even in the case of sabotage e.g. if high-intensity radio waves are superimposed, at least the triggering of a local alarm is still ensured. Further protection against sabotage can be provided by a field-strength measurement sensor which operates an alarm if measured field-strength values change.

It is understood that the olive-shaped window or door fitting with the monitoring and alarm module 1 can also be used autonomously without a central monitoring station and radio transmission of report signals to this.

The olive-shaped window or door fitting can at least be added on in the installation version. In order to reduce the risk of a false alarm, several handling noise sensors 15 can also be provided, in particular if the handling noise sensor 15 cannot be arranged sunk into the frame 5.

The monitoring and alarm module 1 has a replaceable plug-in locking part 6, normally square in cross-section, which is connected to the handle 4 in rotation-resistant manner.

The monitoring and alarm module 1 serves in particular to secure windows and doors encased in a frame 5, with a swivellable handle 4 housed in a handle fitting 2 and with a replaceable plug-in locking part 6, connected to the handle 4. A sensor device in the module housing 26 detects the actuation of the handle 4 with a first sensor 8 and delivers a first detection signal to the evaluation device 24.

A signal-triggering element 12 is arranged in the plug-in locking part 6, wherein the first sensor 8 is attached to the plug-in locking part 12 vis-a-vis the signal-triggering element 8 such that, when the handle 4 is moved out of a predefined swivel position, the first sensor 8 delivers the first detection signal to the evaluation device. Attached to the handle fitting 2 is a second sensor 14 which, when the window or door is in the open position, delivers a second detection signal to the evaluation device 24. The evaluation device 24 recognizes all locking states from the combination of the two detection signals and can deliver a corresponding report signal to a central monitoring station.

The monitoring and alarm module 1 makes it possible not only to monitor the actuation of the handle 4 but also to analyze the handle position and send a corresponding report signal to the central monitoring station.

The evaluation device 24 receives the signals from all the sensors 8, 14, 15 and from these can recognize the locking state of the handle 4. Even if the window or the doors are opened without the handle 4 being actuated, there is at least the second detection signal, with the result that in this case too a corresponding report signal can be generated.

In a preferred embodiment example it is provided that a transmitter 16 transmits the detection signals or the report signal from the evaluation device 24 wirelessly to the central monitoring station. Such a monitoring device has the advantage that it can be installed without costly cabling.

Alternatively it can be provided that a cable transmits the detection signals or the report signal from the evaluation device 24 to the central monitoring station. Such an embodiment example suggests itself if cabling is already present.

Preferably it is provided that the first sensor 8 detects the position of the plug-in locking part 6 in contact-less manner. Such a contact-less recording of the position of the plug-in locking part 6 is wear-free and extensively protected against interfering influences.

Alternatively the position of the plug-in locking part 6 can be mechanically scanned.

The evaluation device 24 consists of a logic circuit which generates a report signal differentiated according to the incoming detection signals.

Alternatively the evaluation device 24 can also be integrated into the monitoring system with the result that the individual detection signals are first evaluated in the central monitoring station.

The transmitter 16 can likewise be integrated into the handle fitting 2 with the result that, to install the monitoring device according to the invention, it is merely necessary to replace the handle fitting 2 with the plug-in locking part 6.

The power supply is in this case likewise integrated into the handle fitting 2.

The first sensor 8 preferably consists of a contactor which detects the position of a magnet attached in or to the plug-in locking part 6 as a signal-triggering element 12.

The first sensor 8 consists of a sealed-contact switch which encloses the plug-in locking part 6 in a U-shape or circularly. Thus it is possible to monitor different swivel positions of the handle with a single sensor 8. When using an N/O contact as sealed-contact switch, the switch is open in a swivel position of the handle 4 in which the magnet at the plug-in locking part 6 is opposite the sealed-contact switch, wherein the sealed-contact switch is closed as soon as the handle 4 is swivelled slightly out of this position.

The sealed-contact switch consists of a switch body opposite the signal-triggering element 12 when the handle 4 is in the closed position and projecting at right-angles or circularly from this switch body.

Furthermore a position sensor integrated into the monitoring and alarm module 1 for roller shutters can transmit a third detection signal to the evaluation device 24. Manoeuvres at the roller shutters are enough to cause this position sensor to transmit a detection signal early to the evaluation device 24 with the result that where necessary an attempted break-in can be noticed very early. The signal-triggering element is fixed to the inside of the roller shutters.

Furthermore an external glassbreak sensor can additionally be connected to the evaluation device 24 and/or the transmitter 16. The glassbreak vibration detector can also be attached in conventional manner to the pane of glass 34, wherein the leads to the evaluation device 24 are run in the handle fitting 3.

The first sensor 8, and a plug-in locking part 6 provided with the signal-triggering element 12, which can be exchanged for the existing plug-in locking part of the olive-shaped window or door fitting, can be added on to an existing olive-shaped window or door fitting. Such an add-on would permit the use of existing handles 4 including the handle fittings 2 without it showing from the outside that the handle is provided with a monitoring device.

Alternatively it can be provided that the first sensor 8, and a plug-in locking part provided with the signal-triggering element 12, which can be exchanged for the existing plug-in locking part 6 of the handle fitting 2, form an add-on unit with its own module housing 26 which can be inserted between the handle fitting and the window or door. In this case an already present handle 4 including the handle fitting 2 can also be used, wherein the module housing 26 of the monitoring and alarm module 1 merely has an extended plug-in locking part added on.

Between the window or the door and the handle fitting 2 or the housing 26 a drill-resistant steel plate can be arranged which protects the electronic elements and the power supply against destruction.

The monitoring and alarm module 1 has at least one sensor device, e.g. comprising a sealed-contact switch 8, which is positioned at and attached to the handle fitting 2 or the module housing 26 such that the sealed-contact switch extends in a specific swivel position of the handle, substantially parallel to an edge of the plug-in locking part 6, square in cross-section.

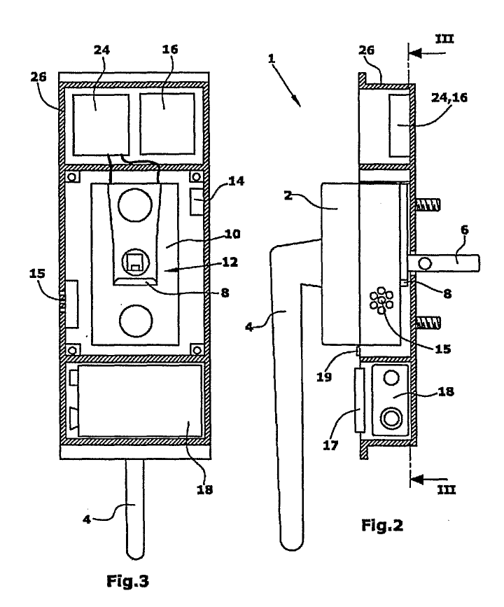

As can be seen from FIG. 2, the sealed-contact switch 8 runs for example parallel to the narrow edge of the rectangular handle fitting 2, while the leads are run parallel to the longitudinal edges of the handle fitting 2 up to an evaluation device 24. The evaluation device 24 can be connected to a transmitter 16 which can transmit the report signal of the monitoring device 24 to a central monitoring station or to the transmitter for an acoustic and/or visual signal 17.

Provided in the lower part of the handle fitting 2 is a compartment for an electricity-supply device 18 which can consist of a battery or cell. The cell can optionally be fed by a solar cell.

The sealed-contact switch 8 can be located on a base plate 10 which can be added on to a handle fitting 2 customary in the trade. The plug-in locking part 6 with a magnet 20 as signal-triggering element 12 is, if added on, exchanged for an existing plug-in locking part. A further sensor 14 which is likewise connected to the evaluation device 24 can be arranged in the module housing 26. Using the second sensor 14, it can be established by means of a signal-triggering element attached to the frame 5 of the window or door whether the door wind or window wing is being opened.

All the lever positions of the handle 4 can be detected by the evaluation device 24 from the combination of the signals of the first and second sensor 8, 14, with the result that a differentiated report signal can be transmitted via the transmitter 16 or a cable connection to the central monitoring station.

1-9. (canceled)

10. An olive-shaped window or door fitting comprising:
a handle fitting;
a handle housed in the handle fitting;
a module housing,
an autonomous monitoring and alarm module disposed in the module housing and having, a plurality of sensors and an evaluation unit configured to receive alarm signals and detection signals, wherein the monitoring and alarm, module has at least one handling noise sensor integrated into the module housing and directed towards a pane of glass for selectively detecting acoustic frequencies occurring when glass is broken and wherein the handling noise sensor transmits an alarm signal to the evaluation device if the glass is being broken.

11. The olive-shaped window or door fitting as recited in claim 10, wherein the handling noise sensor is activatable by a vibration sensor.

12. The olive-shaped window or door fitting as recited in claim 10, wherein the monitoring and alarm module includes an integrated transmitter for at least one of an acoustic and a visual signal.

13. The olive-shaped window or door fitting as recited in claim 10, herein the monitoring and alarm module has at least one status display.

14. The olive-shaped window or door fitting as recited in claim 10, wherein the evaluation device transmits a report signal to a central monitoring station.

15. The olive-shaped window or door fitting as recited in claim 14, further comprising a transmitter for transmitting at least one of the alarm signal the detection signals the report signal from the evaluation device to the central monitoring station.

16. A window or door frame encasing a pane of glass and comprising:
An olive-shaped door fitting including a handle fitting, a handle housed in the handle fitting, a module housing, Land an autonomous monitoring and alarm module disposed in the module housing and having, a plurality of sensors and an evaluation unit configured to receive alarm signals and detection signals, wherein the monitoring and alarm module has at least one handling noise sensor integrated into the module housing and directed towards the pane of glass for selectively detecting acoustic frequencies occurring: when glass is broken and wherein the handling noise sensor transmits an alarm signal to the evaluation device if the glass is being broken;
a recess and
a sound duct leading on the frame from the handling noise sensor to an outer edge of the pane of glass, wherein the module housing is arranged sunk into the recess.

17. The window or door frame as recited in claim 16, further comprising a solar cell supplying the monitoring and alarm m-nodule with current.

18. The window or door frame as recited in claim 17, wherein the solar cell is located at least one of on the pane of glass, in the pane of glass and on the frame.

19. The window or door frame as recited in claim 16, wherein the fitting includes a vibration sensor for activating the handling noise sensor, the vibration sensor being attached at or against the pane of glass.
